(19) United States
(12) Patent Application Publication
(10) Pub. No.: US 2026/0170753 A1
(43) Pub. Date: Jun. 18, 2026

(54) METHOD FOR GENERATING THREE-DIMENSIONAL VIRTUAL SPACE AND TERMINAL FOR IMPLEMENTING SAME

(71) Applicant: LG ELECTRONICS INC., Seoul (KR)

(72) Inventor: Jaehong OH, Seoul (KR)

(73) Assignee: LG ELECTRONICS INC., Seoul (KR)

(21) Appl. No.: 19/124,218

(22) PCT Filed: Nov. 25, 2022
(86) PCT No.: PCT/KR2022/018890

§ 371 Date: Apr. 24, 2025

(51) Int. Cl. G06T 17/00; G06V 20/64

(52) U.S. Cl. CPC G06T 17/00; G06V 20/647

(57) ABSTRACT

The present disclosure relates to a method for anyone, not just an expert, to easily generate a three-dimensional space while minimizing financial and time costs, and a terminal for implementing same. The terminal comprises a display, a memory that includes a three-dimensional object model DB for storing a plurality of three-dimensional object models by category, and a control unit. The control unit controls to: recognize one or more two-dimensional objects from a two-dimensional image; retrieve, from the three-dimensional object model DB, the three-dimensional object models corresponding, respectively, to the one or more two-dimensional objects; generate a three-dimensional virtual space corresponding to the two-dimensional image by using the retrieved three-dimensional object models; and display the three-dimensional virtual space.

### TECHNICAL FIELD

The present disclosure relates to a method for creating a three-dimensional virtual space using a two-dimensional image and a terminal for implementing the same.

### BACKGROUND

User terminals may be generally classified as mobile/portable terminals or stationary terminals according to their mobility. User terminals may also be classified as handheld terminals or vehicle mounted terminals according to whether or not a user can directly carry the terminal

User terminals have become increasingly more functional. Examples of such functions include data and voice communications, capturing images and video via a camera, recording audio, playing music files via a speaker system, and displaying images and video on a display. Some user terminals include additional functionality which supports game playing, while other terminals are configured as multimedia players. More recently, user terminals have been configured to receive broadcast and multicast signals which permit viewing of content such as videos and television programs.

As the functions of such user terminals diversify, the user terminals are implemented in a form of multimedia players with complex functions such as taking pictures or videos, playing music or video files, playing games, and receiving broadcasts.

Recently, three-dimensional virtual spaces are being widely utilized in various designs (e.g., architectural design, space design, interior design, landscape design, and the like) via the user terminals.

When the three-dimensional virtual space is created by a graphic designer using a computer graphic program to utilize the three-dimensional virtual space, it may cost a lot of money and time. Alternatively, the three-dimensional virtual space may be created by scanning an actual site in three-dimensions, but because a 3D scanner is expensive equipment, it is mainly used in some industrial fields that require precise measurements.

A method is required that allows anyone, even non-experts, to easily create the three-dimensional virtual space while minimizing the money and time costs.

### SUMMARY

### Technical Problem

A purpose of the present disclosure is to provide a method that allows anyone, even non-experts, to easily create a three-dimensional virtual space while minimizing money and time costs, and a terminal for implementing the same.

### Technical Solutions

To achieve the above purpose, according to one aspect of the present disclosure, provided is a user terminal including a display, a memory including a three-dimensional object model DB that stores a plurality of three-dimensional object models classified into categories, and a controller that controls such that at least one two-dimensional object is recognized from a two-dimensional image, a three-dimensional object model corresponding to each of the at least one two-dimensional object is searched in the three-dimensional object model DB, and a three-dimensional virtual space corresponding to the two-dimensional image is created using the searched three-dimensional object model and displayed.

The three-dimensional object model DB may store a plurality of two-dimensional object model images corresponding to each three-dimensional object model.

The plurality of two-dimensional object model images corresponding to each three-dimensional object model may be two-dimensional images of each three-dimensional object model viewed from different viewpoints.

The controller may control such that, in selecting a target three-dimensional object model corresponding to a target two-dimensional object among the at least one two-dimensional object, a two-dimensional object model image best matching the target two-dimensional object is searched among the two-dimensional object model images, and a three-dimensional object model corresponding to the searched two-dimensional object model image is selected as the target three-dimensional object model.

The controller may control such that the two-dimensional object model image best matching the target two-dimensional object is inferred among the two-dimensional object model images using a residual neural network (ResNet) artificial neural network.

The controller may control such that spatial information regarding a space where the at least one two-dimensional object is present is obtained from the two-dimensional image.

The spatial information may include information regarding at least one of a center of the space, an orientation of the space, a size of the space, components constituting the space, and a viewpoint for viewing the space.

The controller may control such that space occupancy information of each of the at least one two-dimensional object is obtained.

The space occupancy information may include information regarding at least one of a size of each object, a center of each object, an orientation of each object, a distance of each object from a viewpoint for viewing the space, and an occupied location of each object in the space.

The controller may control such that the three-dimensional virtual space corresponding to the two-dimensional image is created by further utilizing the spatial information and the space occupancy information of each object.

Further, according to one aspect of the present disclosure, provided is a method for creating a three-dimensional virtual space including recognizing at least one two-dimensional object from a two-dimensional image, searching for a three-dimensional object model corresponding to each of the at least one two-dimensional object in a three-dimensional object model DB that stores a plurality of three-dimensional object models classified into categories, and creating a three-dimensional virtual space corresponding to the two-dimensional image using the searched three-dimensional object model.

### Advantageous Effects

Effects of the method for creating the three-dimensional virtual space and the terminal for implementing the same according to the present disclosure will be described as follows.

According to at least one of the various aspects of the present disclosure, anyone, even the non-experts, may easily create the three-dimensional virtual space while minimizing the financial and time costs.

### BRIEF DESCRIPTION OF THE DRAWINGS

FIG. 1 is a schematic block diagram in terms of hardware of a user terminal related to the present disclosure;

FIG. 2 is a schematic block diagram in terms of software of a user terminal in FIG. 1.

FIG. 3 illustrates an example of a two-dimensional image acquired according to one aspect of the present disclosure and at least one object therein.

FIG. 4 is an example of a three-dimensional object model stored in a three-dimensional object model DB according to one aspect of the present disclosure.

FIG. 5 illustrates an example of a two-dimensional image acquired according to one aspect of the present disclosure and at least one object therein.

FIG. 6 illustrates a three-dimensional object model corresponding to each of at least one object in FIG. 5.

FIG. 7 illustrates an example of components constituting a space of a two-dimensional image in FIG. 5.

FIG. 8 illustrates a three-dimensional virtual space corresponding to a two-dimensional image in FIG. 5.

FIG. 9 is a flowchart of creation of a three-dimensional virtual space according to one aspect of the present disclosure.

FIGS. 10 and 11 illustrate examples of a user interface that may be provided to a user for creating a three-dimensional virtual space according to one aspect of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Each of these elements may be configured as a separate individual hardware module or implemented as two or more hardware modules. Two or more elements may be implemented as a single hardware module. In some cases, at least one of these elements may be implemented as software.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

In this disclosure, the expression “at least one of A or B” may mean “A”, “B”, or “A and B”.

User terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of user terminals. However, such teachings apply equally to other types of terminals, such as those types noted above. In addition, these teachings may also be applied to stationary terminals such as digital TV, desktop computers, and the like.

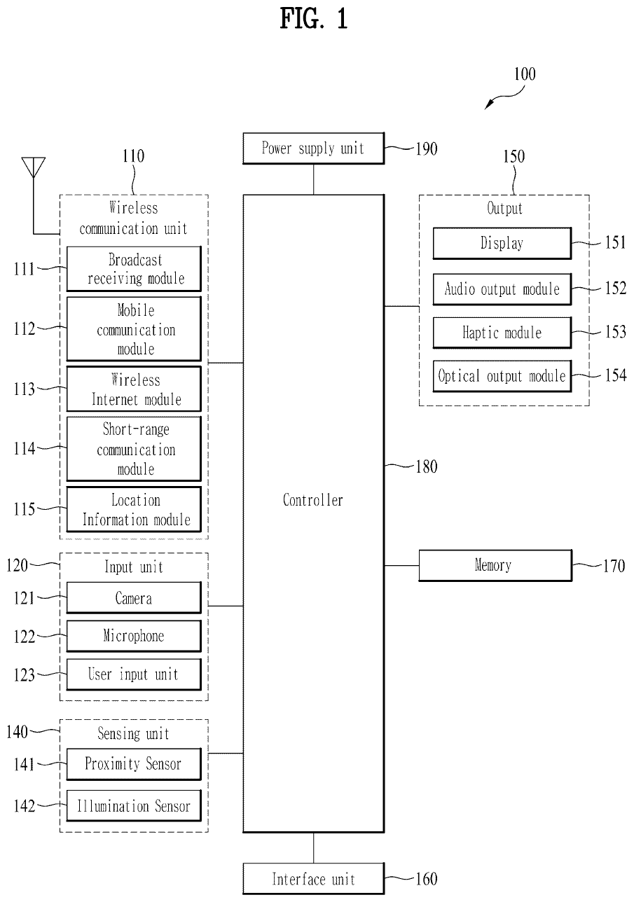

Reference is now made to FIG. 1, which is a block diagram of a user terminal in accordance with the present disclosure.

The user terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the user terminal 100 is shown having wireless communication unit 110 configured with several commonly implemented components. For instance, the wireless communication unit 110 typically includes one or more components which permit wireless communication between the user terminal 100 and a wireless communication system or network within which the user terminal is located.

The wireless communication unit 110 typically includes one or more modules which permit communications such as wireless communications between the user terminal 100 and a wireless communication system, communications between the user terminal 100 and another user terminal, communications between the user terminal 100 and an external server. Further, the wireless communication unit 110 typically includes one or more modules which connect the user terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the user terminal, the surrounding environment of the user terminal, user information, and the like. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The user terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the user terminal 100 and a user, as well as function as the user input unit 123 which provides an input interface between the user terminal 100 and the user.

The interface unit 160 serves as an interface with various types of external devices that can be coupled to the user terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the user terminal 100 may perform assorted control functions associated with a connected external device, in response to the external device being connected to the interface unit 160.

The memory 170 is typically implemented to store data to support various functions or features of the user terminal 100. For instance, the memory 170 may be configured to store application programs executed in the user terminal 100, data or instructions for operations of the user terminal 100, and the like. Some of these application programs may be downloaded from an external server via wireless communication. Other application programs may be installed within the user terminal 100 at time of manufacturing or shipping, which is typically the case for basic functions of the user terminal 100 (for example, receiving a call, placing a call, receiving a message, sending a message, and the like). It is common for application programs to be stored in the memory 170, installed in the user terminal 100, and executed by the controller 180 to perform an operation (or function) for the user terminal 100.

The controller 180 typically functions to control overall operation of the user terminal 100, in addition to the operations associated with the application programs.

In addition, the controller 180 may provide or process information or functions appropriate for a user by processing signals, data, information and the like, which are input or output by the various components depicted in FIG. 1, or activating application programs stored in the memory 170. As one example, the controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the user terminal 100. The power supply unit 190 may include a battery, and the battery may be configured to be embedded in the terminal body, or configured to be detachable from the terminal body.

At least some of the components may operate in cooperation with each other to implement an operation, control, or a control method of the user terminal according to various embodiments to be described below. In addition, the operation, the control, or the control method of the user terminal may be implemented on the user terminal by driving at least one application program stored in the memory 170.

Referring still to FIG. 1, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the user terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external user terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), 5G, and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the user terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A, 5G and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTHTM, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the user terminal 100 and a wireless communication system, communications between the user terminal 100 and another user terminal 100, or communications between the user terminal and a network where another user terminal 100 (or an external server) is located, via wireless area networks. One example of the wireless area networks is a wireless personal area networks.

In some embodiments, another user terminal (which may be configured similarly to user terminal 100) may be a wearable device, for example, a smart watch, a smart glass or a head mounted display (HMD), which is able to exchange data with the user terminal 100 (or otherwise cooperate with the user terminal 100). The short-range communication module 114 may sense or recognize the wearable device, and permit communication between the wearable device and the user terminal 100. In addition, when the sensed wearable device is a device which is authenticated to communicate with the user terminal 100, the controller 180, for example, may cause transmission of data processed in the user terminal 100 to the wearable device via the short-range communication module 114. Hence, a user of the wearable device may use the data processed in the user terminal 100 on the wearable device. For example, when a call is received in the user terminal 100, the user may answer the call using the wearable device. Also, when a message is received in the user terminal 100, the user can check the received message using the wearable device.

The location information module 115 is generally configured to detect, calculate, derive or otherwise identify a position of the user terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the user terminal. As one example, when the user terminal uses a GPS module, a position of the user terminal may be acquired using a signal sent from a GPS satellite. As another example, when the user terminal uses the Wi-Fi module, a position of the user terminal can be acquired based on information related to a wireless access point (AP) which transmits or receives a wireless signal to or from the Wi-Fi module.

The input unit 120 may be configured to permit various types of input to the user terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the user terminal 100. As another example, the cameras 121 may be located in a stereoscopic arrangement to acquire left and right images for implementing a stereoscopic image. Further, the plurality of cameras 121 may include a depth camera and/or a time of flight (TOF) camera for sensing a subject in three dimensions.

The microphone 122 is generally implemented to permit audio input to the user terminal 100. The audio input can be processed in various manners according to a function being executed in the user terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the user terminal 100. The user input unit 123 may include one or more of a mechanical input element (for example, a key, a button located on a front and/or rear surface or a side surface of the user terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the user terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the user terminal, surrounding environment information of the user terminal, user information, or the like. The controller 180 generally cooperates with the sending unit 140 to control operation of the user terminal 100 or execute data processing, a function or an operation associated with an application program installed in the user terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the user terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the user terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the user terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the user terminal 100. For example, the display unit 151 may display execution screen information of an application program executing at the user terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the user terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the user terminal 100.

An optical output module 154 can output a signal for indicating an event generation using light of a light source. Examples of events generated in the user terminal 100 may include message reception, call signal reception, a missed call, an alarm, a schedule notice, an email reception, information reception through an application, and the like.

A signal output by the optical output module 154 may be implemented in such a manner that the user terminal emits monochromatic light or light with a plurality of colors. The signal output may be terminated as the user terminal senses that a user has checked the generated event, for example.

The interface unit 160 serves as an interface for external devices to be connected with the user terminal 100. For example, the interface unit 160 can receive data transmitted from an external device, receive power to transfer to elements and components within the user terminal 100, or transmit internal data of the user terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the user terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the user terminal 100 is connected with an external cradle, the interface unit 160 can serve as a passage to allow power from the cradle to be supplied to the user terminal 100 or may serve as a passage to allow various command signals input by the user from the cradle to be transferred to the user terminal there through. Various command signals or power input from the cradle may operate as signals for recognizing that the user terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The user terminal 100 may also be operated in relation to a network storage device that performs the storage function of the memory 170 over a network, such as the Internet.

The controller 180 may typically control the general operations of the user terminal 100. For example, the controller 180 may set or release a lock state for restricting a user from inputting a control command with respect to applications when a status of the user terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the user terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Functions related to artificial intelligence according to the present disclosure may be operated via the controller 180 and the memory 170. The controller 170 may include one or a plurality of processors. In this regard, one or the plurality of processors may be a general-purpose processor such as a CPU, an AP, a digital signal processor (DSP), or the like, a graphics-only processor such as a GPU or a vision processing unit (VPU), or an artificial intelligence-only processor such as an NPU. One or the plurality of processors may perform control to process input data based on a predefined operation rule or an artificial intelligence model stored in the memory. Alternatively, when one or the plurality of processors are the artificial intelligence-only processor, the artificial intelligence-only processor may be designed with a hardware structure specialized for processing a specific artificial intelligence model.

Artificial Intelligence (AI) refers to a field that studies artificial intelligence or methodology capable of achieving artificial intelligence. Machine learning refers to a field that defines various problems handled in the AI field and studies methodology for solving the problems. Machine learning may also be defined as an algorithm for raising performance for any task through steady experience of the task.

An artificial neural network (ANN) may refer to a model in general having problem solving capabilities, that is composed of artificial neurons (nodes) constituting a network by a combination of synapses, as a model used in machine learning. The ANN may be defined by a connection pattern between neurons of different layers, a learning process of updating model parameters, and/or an activation function for generating an output value.

The ANN may include an input layer, an output layer, and, optionally, one or more hidden layers. Each layer includes one or more neurons and the ANN may include a synapse connecting neurons. In the ANN, each neuron may output input signals, which are input through the synapse, weights, and function values of an activation function for deflection.

A model parameter refers to a parameter determined through learning and includes a weight of synaptic connection and a deflection of a neuron. A hyperparameter refers to a parameter that should be configured before learning in a machine learning algorithm and includes a learning rate, the number of repetitions, a mini batch size, an initialization function, and the like.

The purpose of learning of the ANN may be understood as determining the model parameter that minimizes a loss function. The loss function may be used as an index to determine an optimal model parameter in a learning process of the ANN.

Machine learning may be classified into supervised learning, unsupervised learning, and reinforcement learning, according to a learning scheme.

Supervised learning refers to a method of training the ANN in a state in which a label for training data is given. The label may represent a correct answer (or result value) that the ANN should infer when the training data is input to the ANN. Unsupervised learning may refer to a method of training the ANN in a state in which the label for the training data is not given. Reinforcement learning may refer to a learning method in which an agent defined in a certain environment is trained to select a behavior or a behavior order that maximizes accumulative compensation in each state.

Among ANNs, machine learning implemented as a deep neural network (DNN) including a plurality of hidden layers is also called deep learning. Deep learning is a part of machine learning. Hereinbelow, machine learning includes deep learning.

An object detection model using machine learning includes a you only look once (YOLO) model of a single-step scheme, a faster regions with convolution neural networks (R-CNN) model of a two-step scheme, and the like.

The you only look once (YOLO) model is a model in which an object existing in an image and a position of the corresponding object may be predicted as the image is viewed only once.

The you only look once (YOLO) model divides the original image into grids of the same size. Then, for each grid, the number of bounding boxes specified in a predefined form around a center of the grid is predicted, and reliability is calculated based on the predicted number.

Thereafter, whether the image contains the object or contains only a background may be included, and a location with high object reliability may be selected, so that an object category may be identified.

The faster regions with convolution neural networks (R-CNN) model is a model that may detect the object faster than an RCNN model and a Fast RCNN model.

The faster regions with convolution neural networks (R-CNN) model will be described in detail.

First, a feature map is extracted from the image via a convolution neural network (CNN) model. Based on the extracted feature map, a plurality of regions of interest (RoIs) are extracted. RoI pooling is performed for each region of interest.

The RoI pooling is a process of setting grids of a feature map to which the regions of interest are projected to fit a H×W size that is determined in advance and extracting the greatest value for each cell included in each grid to extract a feature map having the H×W size.

A feature vector may be extracted from the feature map having the H×W size, and identification information of the object may be obtained from the feature vector.

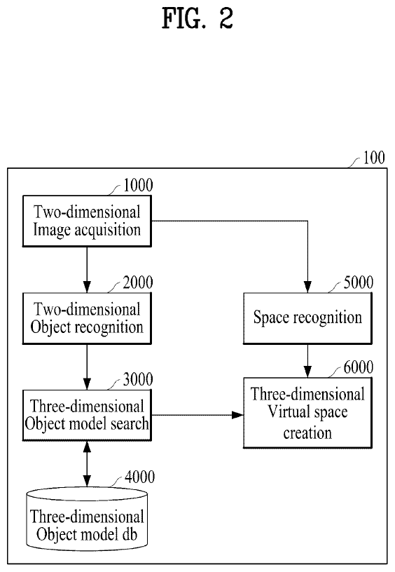

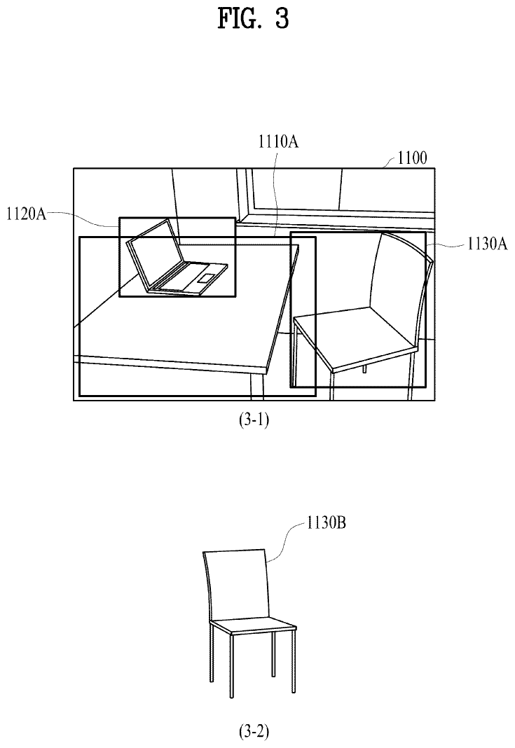

The user terminal related to the present disclosure has been described from a hardware perspective. Hereinafter, with reference to FIGS. 2 and 3, the user terminal in FIG. 1 will be described from a perspective of software that may operate according to one aspect of the present disclosure. FIG. 2 is a schematic block diagram of a user terminal in FIG. 1 from a software perspective. FIG. 3 illustrates an example of a two-dimensional image acquired according to one aspect of the present disclosure and at least one object therein.

A user terminal 1000 may include a two-dimensional image acquisition module 1000, a two-dimensional object recognition module 2000, a three-dimensional object model search module 3000, a three-dimensional object model database (DB) module 4000, a space recognition module 5000, and a three-dimensional virtual space creation module 6000.

For example, the two-dimensional image acquisition module 1000 may be constituted by at least one of the sensor for acquiring the two-dimensional image (e.g., the RGB sensor, the infrared sensor, the light sensor, and the like) in the sensing unit 140 and the camera 121. The two-dimensional object recognition module 2000, the three-dimensional object model search module 3000, the space recognition module 5000, and the three-dimensional virtual space creation module 6000 may be built via the controller 180 that cooperates with the memory 170. The three-dimensional object model DB module 4000 may be built via the memory 170.

The two-dimensional image acquisition module 1000 may acquire a two-dimensional image 1100 as shown in (3-1) in FIG. 3 by taking a photo or performing a 2D scanning. The above-mentioned acquired two-dimensional image 1100 may be basic information for creating a three-dimensional virtual space to be described later.

The two-dimensional object recognition module 2000 may recognize at least one two-dimensional object 1110A, 1120A, and 1130A in the two-dimensional image 1100, as shown in (3-1) in FIG. 3. The at least one two-dimensional object 1110A, 1120A, and 1130A may be at least one object occupying a space in the two-dimensional image 1100. In (3-1) in FIG. 3, the at least one two-dimensional object 1110A, 1120A, and 1130A is illustrated as including a first object 1110A, a second object 1120A, and a third object 1130.

The two-dimensional object recognition module 2000 may infer and identify the at least one two-dimensional object 1110A, 1120A, and 1130A present in the two-dimensional image 1100 using an artificial neural network such as the YOLO, for example. That is, the object recognition module 2000 may identify that the first object 1110A belongs to a first category, the second object 1120A belongs to a second category, and the third object 1130A belongs to a third category. In FIG. 3, it may be understood that the first category corresponds to a table category, the second category corresponds to a laptop category, and the third category corresponds to a chair category.

The three-dimensional object model DB 4000 may store a plurality of three-dimensional object models prepared in advance in a manner of classifying them into categories. The three-dimensional object model DB 4000 may store a plurality of two-dimensional object model images corresponding to each three-dimensional object model. The plurality of two-dimensional object model images may be two-dimensional images that view one same three-dimensional object model from different viewpoints.

The three-dimensional object model search module 3000 may search for at least one three-dimensional object model respectively corresponding to the at least one two-dimensional object 1110A, 1120A, and 1130A from the three-dimensional object model DB 4000 using an artificial neural network such as a residual neural network (Resnet) in a multi layer perceptron (MLP) method. In (3-2) in FIG. 3, a three-dimensional object model 1130A corresponding to the third object 1130A is illustrated.

In one example, the space recognition module 5000 may recognize a space in the two-dimensional image 1100, i.e., a space in which the at least one two-dimensional object is present using the artificial neural network such as the Resnet. In (3-1) in FIG. 3, the space in the two-dimensional image 1100 is illustrated as an office or a room. In this case, the space recognition module 5000 may identify spatial information regarding at least one of i) a center of the space (or a layout), ii) an orientation of the space, iii) a size of the space, iv) components (e.g., a wall surface, a floor, and the like) constituting the space, and v) a viewpoint from which the space is viewed.

The three-dimensional virtual space creation module 6000 may create the three-dimensional virtual space based on the one three-dimensional object model and the spatial information.

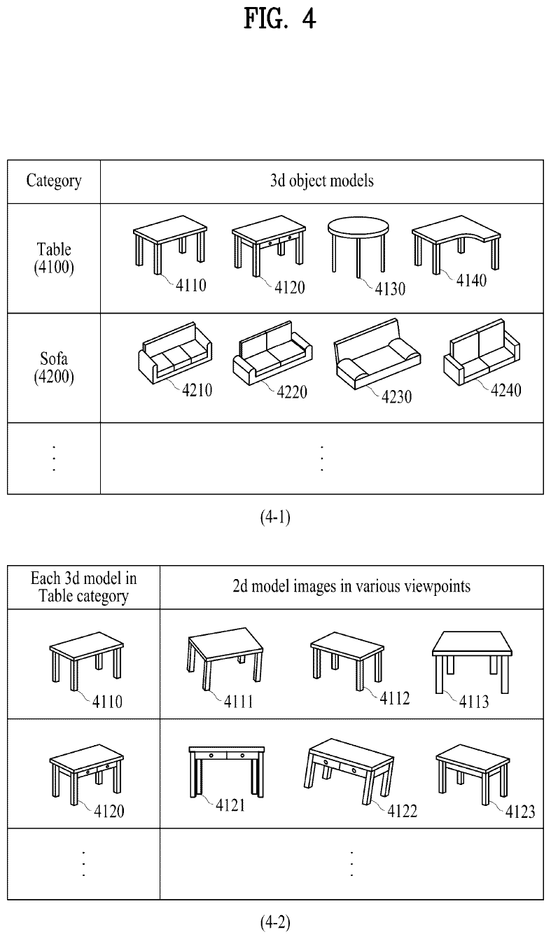

Hereinafter, the three-dimensional object model DB 4000 will be described in more detail with reference to FIG. 4. FIG. 4 is an example of a three-dimensional object model stored in a three-dimensional object model DB according to one aspect of the present disclosure.

As shown in (4-1) in FIG. 4, the three-dimensional object model DB 4000 may store at least one three-dimensional object model for each category prepared in advance. In (4-1) in FIG. 4, for example, it is exemplified that a first table model 4110, a second table model 4120, a third table model 4130, and a fourth table model 4140 are included in a table category 4100, and a first sofa model 4210, a second sofa model 4220, a third sofa model 4230, and a fourth sofa model 4240 are included in a sofa category 4200. In one example, there are more categories in the three-dimensional object model DB 4000. The three-dimensional object model may also be generated by graphic work using an existing computer graphic program or three-dimensional scanning using a 3D scanner.

In addition, as shown in (4-2) in FIG. 4, a plurality of two-dimensional object model images corresponding to each three-dimensional object model may be prepared in advance and stored in the three-dimensional object model DB 4000. The plurality of two-dimensional object model images may be images of one same three-dimensional object model viewed from different viewpoints. In (4-2) in FIG. 4, two-dimensional first table model image 4111, second table model image 4112, and third table model image 4113 viewed from different viewpoints of the three-dimensional first table model 4110 are exemplified, and two-dimensional fourth table model image 4121, fifth table model image 4122, and third table model image 4123 viewed from different viewpoints of the three-dimensional second table model 4120 are exemplified. The two-dimensional object model images may be prepared by rotating the three-dimensional object model at an appropriate angle and capturing the same.

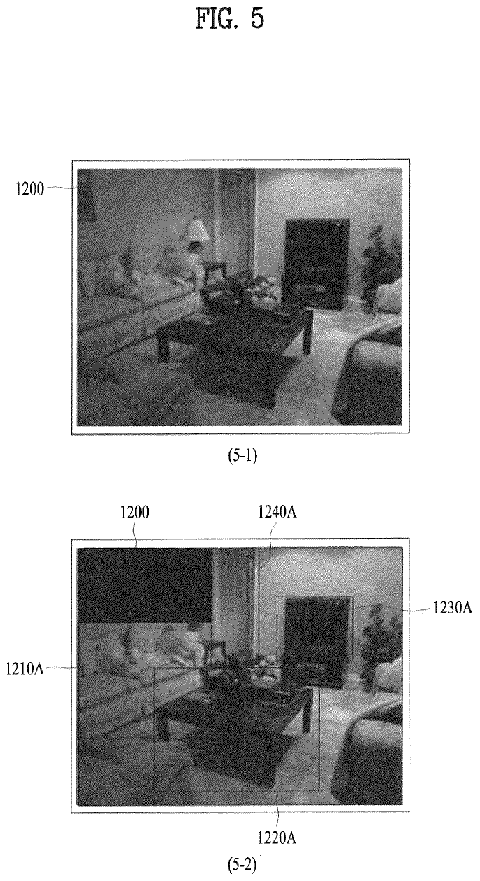

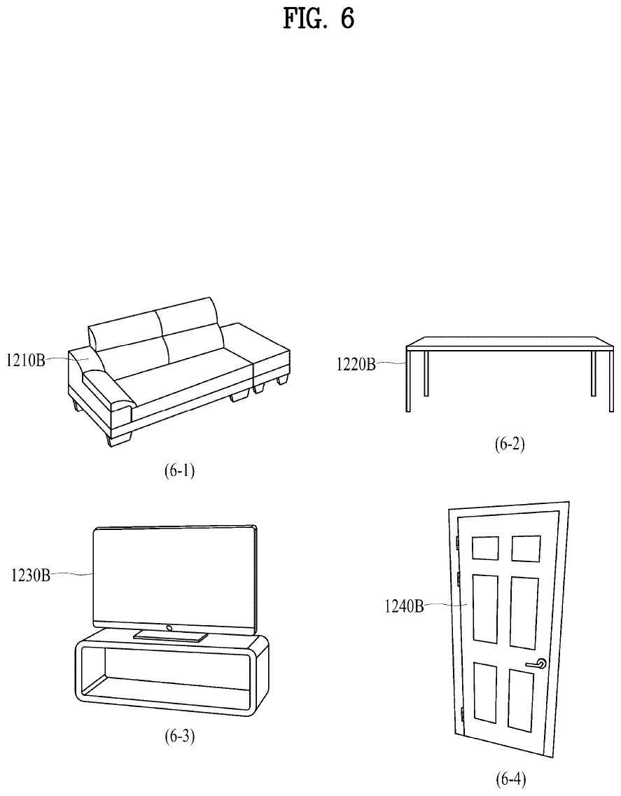

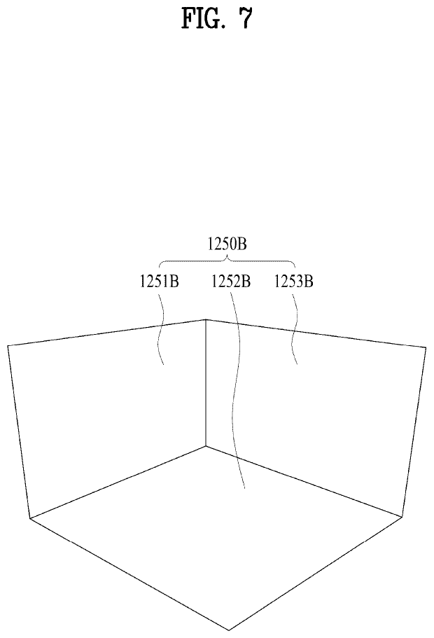

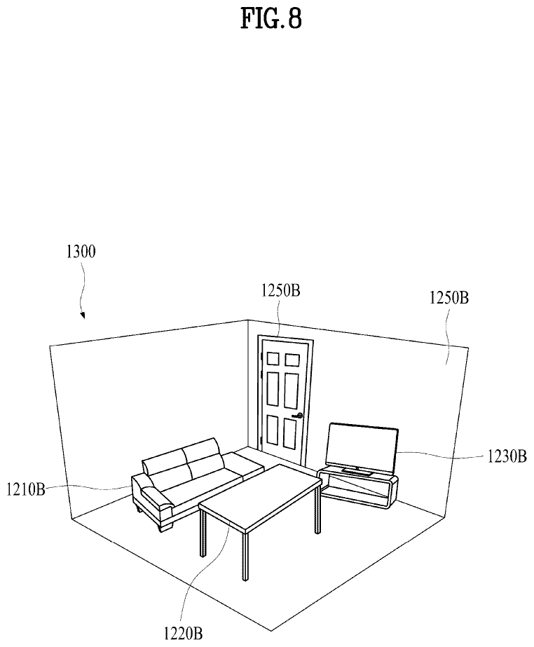

The creation of the three-dimensional virtual space based on the three-dimensional object model DB 4000 will be described further with reference to FIGS. 5 to 8. FIG. 5 illustrates an example of a two-dimensional image acquired according to one aspect of the present disclosure and at least one object therein. FIG. 6 illustrates a three-dimensional object model corresponding to each of at least one object in FIG. 5. FIG. 7 illustrates an example of components constituting a space of a two-dimensional image in FIG. 5. FIG. 8 illustrates a three-dimensional virtual space corresponding to a two-dimensional image in FIG. 5.

The two-dimensional image acquisition module 1000 may acquire a two-dimensional image 1200 as shown in (5-1) in FIG. 5 by taking a photo or performing a 2D scanning. The acquired two-dimensional image 1100 may be basic information for creating the three-dimensional virtual space.

The two-dimensional object recognition module 2000 may recognize at least one two-dimensional object 1210A, 1220A, 1230A, and 1240A within the two-dimensional image 1200, as shown in (5-2) in FIG. 5. The at least one two-dimensional object 1210A, 1220A, 1230A, and 1240A may be at least one object occupying a space within the two-dimensional image 1100. In (5-1) in FIG. 5, it is exemplified that the at least one two-dimensional object 1210A, 1220A, 1230A, and 1240A includes a first object 1210A, a second object 1220A, a third object 1230, and a fourth object 1240A. In addition, it is exemplified that the first object 1210A belongs to a sofa category, the second object 1220 belongs to a table category, the third object 1230A belongs to a home appliance category, and the fourth object 1240A belongs to a door category.

As shown in FIG. 6, the three-dimensional object model search module 3000 may search for three-dimensional object models 1210B, 1220B, 1230B, and 1240B respectively corresponding to the at least one two-dimensional object 1210A, 1220A, 1230A, and 1240A from the three-dimensional object model DB 4000.

A three-dimensional first object model 1210B corresponding to the two-dimensional first object 1210A is exemplified in (6-1) in FIG. 6, a three-dimensional second object model 1220B corresponding to the two-dimensional second object 1220A is exemplified in (6-2) in FIG. 6, a three-dimensional third object model 1230B corresponding to the two-dimensional third object 1230A is exemplified in (6-3) in FIG. 6, and a three-dimensional fourth object model 1240B corresponding to the two-dimensional fourth object 1240A is exemplified in (6-4) in FIG. 6.

As described above with respect to FIG. 4, the three-dimensional object model DB 4000 may store a plurality of two-dimensional object images corresponding to each of the three-dimensional object models 1210B, 1220B, 1230B, and 1240B.

The three-dimensional object model search module 3000 may search for a two-dimensional object image that best matches the target two-dimensional object 1210A, 1220A, 1230A, and 1240A among the plurality of two-dimensional object images using an artificial neural network, and may select a three-dimensional object model having the searched two-dimensional object image as a three-dimensional object model of the target two-dimensional object.

In one example, as shown in FIG. 7, the space recognition module 5000 may recognize a space 1250B (or a frame or layout defining the space) within the two-dimensional image 1200 using the artificial neural network. The space recognition module 5000 may identify spatial information regarding components constituting the space 1250B (e.g., two wall surfaces 1251B and 1253B, a floor 1252B, and the like) and a viewpoint from which the space is viewed.

The three-dimensional virtual space creation module 6000 may create a three-dimensional virtual space 1300 corresponding to the two-dimensional image 1200, as shown in FIG. 8, based on the one three-dimensional object model 1210B, 1220B, 1230B, and 1240B and the spatial information.

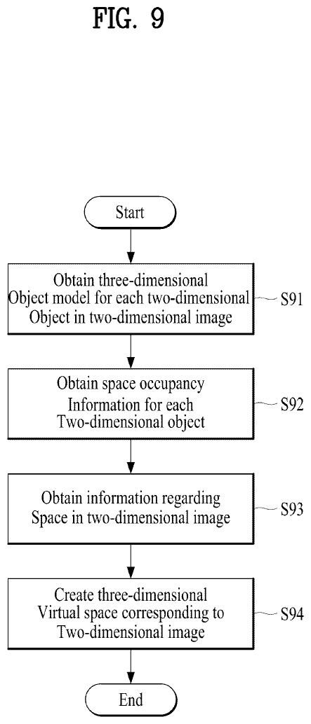

Hereinafter, the creation of the three-dimensional virtual space will be described in more detail with reference to FIG. 9. FIG. 9 is a flowchart of creation of a three-dimensional virtual space according to one aspect of the present disclosure.

As described above, the three-dimensional object model for each object in the two-dimensional image may be obtained via collaboration between the two-dimensional object recognition module 2000, the three-dimensional object model search module 3000, and the three-dimensional object model DB 4000 [S91].

The two-dimensional object recognition module 2000 may obtain space occupancy information for each of the recognized two-dimensional objects using the artificial neural network such as the residual neural network (Resnet) in the multi layer perceptron (MLP) method while recognizing the at least one two-dimensional object present in the two-dimensional image 1100 [S92]. The space occupancy information of the object may include information regarding at least one of i) a size of the object, ii) a center of the object, iii) an orientation of the object, iv) a distance of the object from the viewpoint for viewing the space, and v) an occupied location in the space.

In one example, as described above, the space recognition module 5000 may obtain the spatial information regarding the space in the two-dimensional image [S93].

The three-dimensional virtual space creation module 6000 may create the three-dimensional virtual space using the three-dimensional object model, the space occupancy information for each object, and the spatial information [S94]. The three-dimensional virtual space creation module 6000 may create the layout 1250B for the three-dimensional virtual space based on the spatial information, and may place each three-dimensional object model corresponding to the two-dimensional object in the layout 1250B based on the space occupancy information of each two-dimensional object.

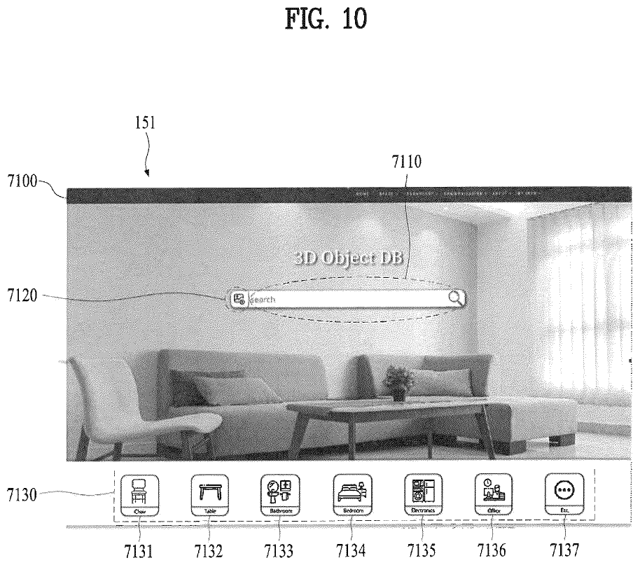

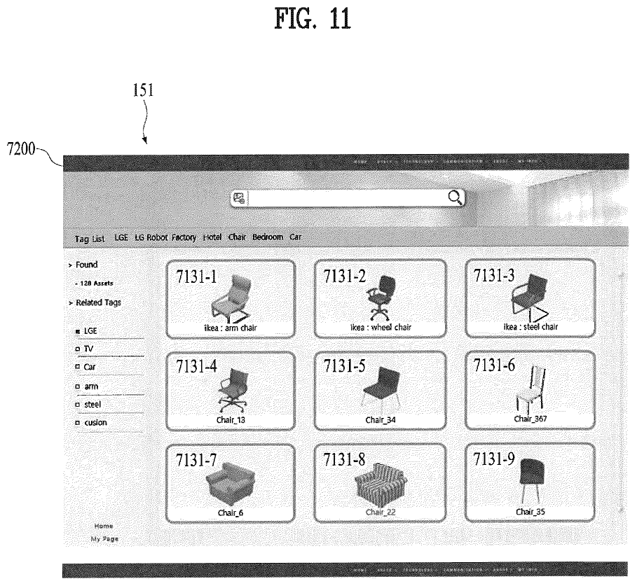

Hereinafter, with reference to FIGS. 10 and 11, a user interface that may be provided to the user via the user terminal 100 for creating the three-dimensional virtual space will be described. FIGS. 10 and 11 illustrate examples of a user interface that may be provided to a user for creating a three-dimensional virtual space according to one aspect of the present disclosure.

The controller 180 may control a first user interface 7100 as shown in FIG. 10 to be displayed on the display 151.

On the first user interface 7100, a search word input box 7110 for searching the three-dimensional object model via text, an image input icon 7120 for searching the three-dimensional object model via an image, and a three-dimensional object model category list 7130 may be displayed.

When the search word input box 7110 is selected and a desired search word is entered into the search word input box 7110 via the user input unit 123, the controller 180 may display at least one three-dimensional object model corresponding to the search word. The user may select and combine desired three-dimensional object models among the three-dimensional object models being searched, thereby creating a desired three-dimensional virtual space.

The selection may be performed by a click or a touch of the mouse cursor on the corresponding graphic. The same applies below.

When the image input icon 7120 is selected and a desired two-dimensional image is input via the camera 121 or from the memory 170, the controller 180 may search for at least one three-dimensional object model respectively corresponding to at least one two-dimensional object in the two-dimensional image, and may create the three-dimensional virtual space using the searched three-dimensional object model. This is as described above.

In one example, in the three-dimensional object model category list 7130, categories 7131, 7132, 7133, 7134, 7135, 7136, and 7137 of the three-dimensional object models stored in the three-dimensional object model DB 4000 may be displayed.

When one category 7131 is selected among those, the controller 180 may control a second user interface 7200 as shown in FIG. 11 to be displayed on the display 151.

On the second user interface 7200, a plurality of three-dimensional object models 7131-1, 7131-2, 7131-3, 7131-4, 7131-5, 7131-6, 7131-7, 7131-8, and 7131-9 belonging to the selected category 7131 may be displayed. The user may also create the desired three-dimensional virtual space by selecting and combining desired three-dimensional object models among the plurality of three-dimensional object models.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The foregoing embodiments are merely exemplary and are not to be considered as limiting the present disclosure. It should be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A user terminal comprising:
a display;
a memory including a three-dimensional object model DB configured to store a plurality of three-dimensional object models classified into categories; and
a controller configured to control such that:
at least one two-dimensional object is recognized from a two-dimensional image;
a three-dimensional object model corresponding to each of the at least one two-dimensional object is searched in the three-dimensional object model DB; and
a three-dimensional virtual space corresponding to the two-dimensional image is created using the searched three-dimensional object model and displayed.

2. The user terminal of claim 1, wherein the three-dimensional object model DB is configured to store a plurality of two-dimensional object model images corresponding to each three-dimensional object model.

3. The user terminal of claim 2, wherein the plurality of two-dimensional object model images corresponding to each three-dimensional object model are two-dimensional images of each three-dimensional object model viewed from different viewpoints.

4. The user terminal of claim 3, wherein the controller is configured to control such that, in selecting a target three-dimensional object model corresponding to a target two-dimensional object among the at least one two-dimensional object, a two-dimensional object model image best matching the target two-dimensional object is searched among the two-dimensional object model images, and a three-dimensional object model corresponding to the searched two-dimensional object model image is selected as the target three-dimensional object model.

5. The user terminal of claim 4, wherein the controller is configured to control such that the two-dimensional object model image best matching the target two-dimensional object is inferred among the two-dimensional object model images using a residual neural network (ResNet) artificial neural network.

6. The user terminal of claim 1, wherein the controller is configured to control such that spatial information regarding a space where the at least one two-dimensional object is present is obtained from the two-dimensional image.

7. The user terminal of claim 6, wherein the spatial information includes information regarding at least one of a center of the space, an orientation of the space, a size of the space, components constituting the space, and a viewpoint for viewing the space.

8. The user terminal of claim 6, wherein the controller is configured to control such that space occupancy information of each of the at least one two-dimensional object is obtained.

9. The user terminal of claim 8, wherein the space occupancy information includes information regarding at least one of a size of each object, a center of each object, an orientation of each object, a distance of each object from a viewpoint for viewing the space, and an occupied location of each object in the space.

10. The user terminal of claim 8, wherein the controller is configured to control such that the three-dimensional virtual space corresponding to the two-dimensional image is created by further utilizing the spatial information and the space occupancy information of each object.

11. A method for creating a three-dimensional virtual space, the method comprising:
recognizing at least one two-dimensional object from a two-dimensional image;
searching for a three-dimensional object model corresponding to each of the at least one two-dimensional object in a three-dimensional object model DB configured to store a plurality of three-dimensional object models classified into categories; and
creating a three-dimensional virtual space corresponding to the two-dimensional image using the searched three-dimensional object model.

12. The method of claim 11, wherein the three-dimensional object model DB is configured to store a plurality of two-dimensional object model images corresponding to each three-dimensional object model.

13. The method of claim 12, wherein the plurality of two-dimensional object model images corresponding to each three-dimensional object model are two-dimensional images of each three-dimensional object model viewed from different viewpoints.

14. The method of claim 13, further comprising, in selecting a target three-dimensional object model corresponding to a target two-dimensional object among the at least one two-dimensional object, searching for a two-dimensional object model image best matching the target two-dimensional object among the two-dimensional object model images, and selecting a three-dimensional object model corresponding to the searched two-dimensional object model image as the target three-dimensional object model.

15. The method of claim 14, further comprising inferring the two-dimensional object model image best matching the target two-dimensional object among the two-dimensional object model images using a residual neural network (ResNet) artificial neural network.

16. The method of claim 11, further comprising obtaining spatial information regarding a space where the at least one two-dimensional object is present from the two-dimensional image.

17. The method of claim 16, wherein the spatial information includes information regarding at least one of a center of the space, an orientation of the space, a size of the space, components constituting the space, and a viewpoint for viewing the space.

18. The method of claim 16, further comprising obtaining space occupancy information of each of the at least one two-dimensional object.

19. The method of claim 18, wherein the space occupancy information includes information regarding at least one of a size of each object, a center of each object, an orientation of each object, a distance of each object from a viewpoint for viewing the space, and an occupied location of each object in the space.

20. The method of claim 18, further comprising creating the three-dimensional virtual space corresponding to the two-dimensional image by further utilizing the spatial information and the space occupancy information of each object.
